(19) United States
(12) Patent Application Publication
(10) Pub. No.: US 2016/0150067 A1
(43) Pub. Date: May 26, 2016

(54) SYSTEMS AND APPARATUSES FOR POSITIONING AND DISPLAYING A MOBILE DEVICE

(71) Applicant: Hashmat Khaliqi, Doha (QA)

(72) Inventor: Hashmat Khaliqi, Doha (QA)

(21) Appl. No.: 14/550,620

(22) Filed: Nov. 21, 2014

(51) Int. Cl. H04M 1/725; F16M 11/14

(52) U.S. Cl. CPC H04M 1/72527; F16M 11/14

(57) ABSTRACT

Holding apparatuses accommodate mobile devices for display and/or interaction in set positions. Apparatuses include a stand and a moveable holder to which a mobile device secures. The holder can be positioned at a number of different angles, orientations, and locations through proper stand-holder joining. The joining may use locks or resistance pieces that prevent rotation or other movement without human force. The holder may be sized and shaped to accommodate a number of different portable electronic devices, with openings, spaces, and locking mechanisms, if any, positioned based on anticipated presence of mobile device features in the holder. Holding apparatuses can include or omit electronics and power sources. Holding apparatuses may be any desired material, including frictional, adhesive, magnetic, or design-based materials. Sound-carrying passages may passively direct audio from a portable electronic device to a front speaker for amplification and direction to a viewer.

### BACKGROUND

Portable electronic devices often include large screens or other viewable features as well as speakers or other auditory devices for performance and consumption of videos, applications, video calls, and other media. Such devices have become increasingly powerful while decreasing in size and weight, allowing them to be transported nearly anywhere for media consumption. Resultantly, many users may use or watch a performance through a mobile device while engaging in other activities, such as cleaning, working, holding on a telephone, cooking, receiving instruction, waiting for an appointment or travel, readying for bed, eating, etc. Typically, users may prop mobile devices against a wall or lay devices flat on a surface for viewing and other media consumption. Users may also place mobile devices in a case that includes a support or prop to allow static positioning of the device upright on a flat surface.

### SUMMARY

Example embodiments include apparatuses that hold mobile devices in desired positions for display and/or interaction. Example embodiments include a base and a viewer that are moveable relative to one another so that a mobile device secured to the viewer—such as in a frame, receiver, sleeve, gripping surface, etc.—can be positioned at a number of different angles, orientations, and locations. The base and the viewer can be joined in any way to provide for desired movement and positioning, including a ball-and-socket type joint with appropriate clearances. The socket—such as one including a ball-shaped cavity—can capture the ball while still permitting rotation of the viewer about three rectilinear axes. The joining may use locking devices, like frictional or adhesive surfaces or latches or locking pieces, that prevent rotation or other movement without human force, so that the mobile device can be continuously displayed at a set position. Example embodiments may be sized and shaped to accommodate a number of different portable electronic devices. Openings, spaces, and locking mechanisms can be positioned based on anticipated presence of mobile device features. Example embodiments can be fabricated and compatible with or without additional electronics. For example, some example consoles may be entirely plastic so as to reduce manufacturing costs, with no electrical options. Sound-carrying passages may passively direct audio from a portable electronic device in the console to a front speaker for amplification and direction to a viewing user.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of an example embodiment mobile device console.

FIG. 2 is an illustration of another example embodiment mobile device console.

FIG. 3 is an illustration of another example embodiment mobile device console.

FIG. 4 is an isometric view of the example embodiment mobile device console of FIG. 3 in a first configuration.

FIG. 5 is an isometric view of the example embodiment mobile device console of FIG. 3 in a second configuration.

FIG. 6 is an isometric view of the example embodiment mobile device console of FIG. 3 in a third configuration.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, “and” and “or” are equivalent to the term “and/or,” which includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange routes between two devices, including intermediary devices, networks, etc., connected wirelessly or not.

As used herein, the singular forms “a”, “an” and “the” and the plural form “indicia” are intended to include both the singular and plural forms, unless the language explicitly indicates otherwise. It will be further understood that the terms “comprises,” “comprising,” “includes,” and/or “including,” when used herein, specify the presence of stated features, integers, steps, operations, elements, and/or components, but do not themselves preclude the presence or addition of one or more other features, integers, steps, operations, elements, components, and/or groups thereof.

It should also be noted that the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from the single operations described below. It should be presumed that any embodiment having features and functionality described below, in any workable combination, falls within the scope of example embodiments.

As used herein, “mobile device” and “portable electronic device” are used interchangeably to describe non-stationary electronics with capability of audiovisual performance and local powering, such as with an internal battery. Under this definition, mobile devices include at least tablet computers, phones, laptops, wearable computers, monitors, readers, etc. Where example embodiments are configured to interact with mobile devices, this requires a purposeful design to accommodate, through shaping, sizing, and functionality, one or more third-party mobile device(s).

The inventor has recognized that mobile devices are increasingly being used like television sets, except that unlike typical TVs, portable electronics do not occupy a stationary location within a household or other viewing area. This often results in portable electronic devices being laid flat or propped up in viewing areas while the human user goes about other tasks or focuses on watching. The inventor has recognized that typical props, such as walls or supports or extensions in device cases, do not permit flexibility in device positioning for viewing. Nor do typical props offer a stable viewing location with any resistance to falling, vibration, or incidental bumping. Nor do typical props account for speaker positioning and acoustical loss due to propping. To overcome these newly-recognized problems as well as others, the inventor has developed systems that allow flexible and stable mobile device positioning without sacrificing portability of the device, while potentially enhancing acoustic and user interaction with mobile devices being viewed or otherwise used.

The present invention is devices or systems for holding and displaying a portable electronic device. In contrast to the present invention, the few example embodiments and example methods discussed below illustrate just a subset of the variety of different configurations that can be used as and/or in connection with the present invention.

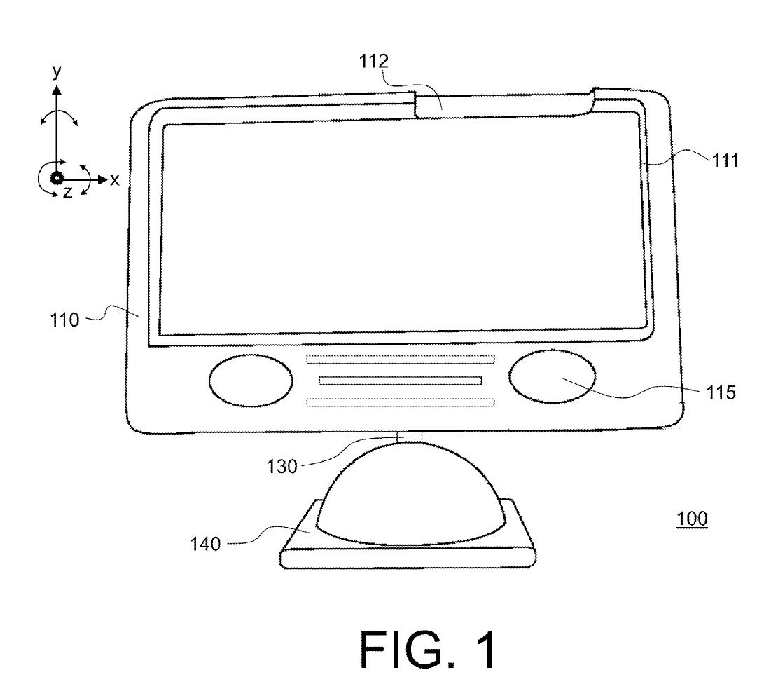

FIG. 1 is an illustration of an example embodiment portable electronic device console 100. As shown in FIG. 1, example embodiment console 100 includes a movable frame 110 shaped to accommodate a portable electronic device. For example, as shown in FIG. 1, frame 110 may include an inset 111 of a standard mobile device size. In this way, a mobile device can be set into inset 111 and retained in the same for viewing. For example, inset 111 may be sized to the dimensions of known mobile devices, such as mobile phones, tablet computers, wearable electronics, handheld game consoles, GPS devices, laptop computers, personal readers, etc. Inset 111 may further include sizeable elements, such as a compressible foam, moldable putty, or adjustable edges, to accommodate devices of several different sizes. Similarly, movable frame 110 may include different or additional capturing structures, like extensions, adhesives, suction cups, etc. that accommodate portable electronic devices and maintain the same in relative positioning with frame 110.

Inset 111 may include a bevel, ledge, or capturing extension about one or more edges of inset 111 to prevent a portable electronic device inserted therein from easily falling out or changing relative position. Similarly, inset 111 may include a frictional or adhesive structure to secure mobile devices therein. For example, a foam tape, rubber backing, Velcro, or non-sticky adhesive surface may be affixed within inset 111 to better capture a mobile device inserted therein. Still further, inset 111 may include a movable release and/or lock to allow a mobile device to be inserted into inset 111 and subsequently held in place by engagement of the lock. For example, a mobile device may be slid into inset 111 in a single direction, such as in the horizontal x dimension, behind a catching ledge. When fully slid into inset 111, a moveable extension from an edge of inset 111 may be engaged to block the mobile device from exiting inset 111, regardless of orientation, gravity, or other forces.

Inset 111 may include an access break 112 that allows a user to access controls of mobile devices contained therein. For example, access break 112 may extend through a ledge or bevel of inset 111 or be a hole that allows a user to depress volume, power, or other controls, as well as access ports or jacks in, a mobile device in inset 111. Of course, several access breaks 112 may be included for several disparately-located controls and/or access points.

Mobile frame 110 may further include one or more speakers 115 opening from a front or side. Speaker 115 may be electronic and use a local or remote power source. An electronic speaker 115 may amplify audio output from a mobile device via a receiver or microphone in frame 110; an electronic speaker 115 may also connect via a dock, data port, or headphone jack to a mobile device to output amplified audio from the device. Speaker 115 may also be passive. As described in further detail below, speaker 115 may be connected to speakers of a mobile device so as to passively amplify and/or direct sound to a user at a front of example embodiment console 100. In this way, example embodiment console 100 may lack any electronics or powered features or connections, and a mobile device used therein may be powered solely by its battery. This may simplify and increase portability of some example embodiments lacking external power options.

Mobile frame 110 may be translatable and/or rotatable in any dimension. For example, as shown in FIG. 1, frame 110 may rotate in any or all of three perpendicular axes x, y, and/or z in horizontal, vertical, and/or depth dimensions, respectively. Similarly, mobile frame 110 may be translatable in any of the x, y, and/or z directions. In this way, a user may rotate or move frame 110 holding a mobile device to any desired location or angle in order to optimize viewing and/or interaction. Such movement can be achieved via any number of moving and joining structures, some of which are described below.

Example embodiment console 100 further includes a base 140 that securely sits on a surface. Base 140 may be relatively heavy and/or have a larger area expanding about mobile frame 110 to provide leverage against forced applied to frame 110 and/or prevent tipping and/or slipping of console 100. Base 140 may further include adhesive surfaces or locking mechanisms, like suctions or clamping grips, that prevent slipping or tipping as well as permitting base 140 to be secured to non-flat, horizontal, or irregular surfaces without relative movement. Base 140 and mobile frame 110 may be connected in any way that permits articulation of frame 110 in any desired dimension(s) and/or axi(e)s. For example, a neck 130 may extend between base 140 and frame 110 and secure the two together.

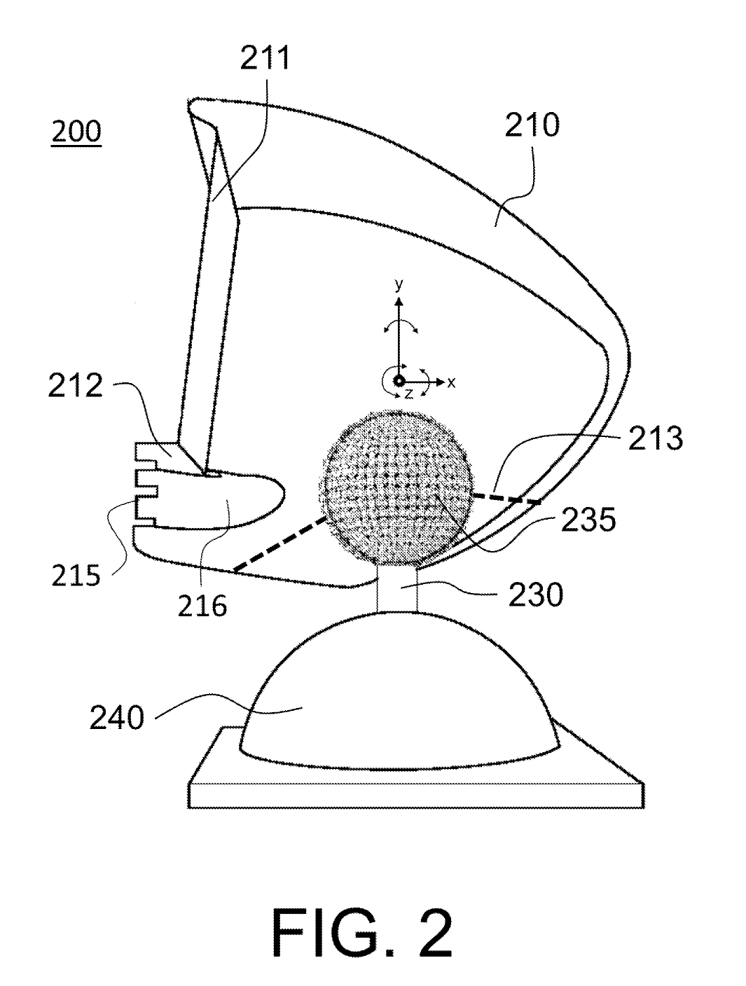

FIG. 2 is an illustration of another example embodiment mobile device console 200 shown as a cut-out profile. It is understood that example embodiment consoles 100 and 200 may include interchangeable parts and may include optional features useable by either.

As shown in FIG. 2, mobile frame 210 includes an inset 211 with a capturing edge 212 at a bottom of inset 211. In this way, a mobile device may be slid into inset 211 (such as in a depth direction into FIG. 2) behind capturing edge 212. Inset 211 may be formed with a bevel from frame 210, such that a mobile device slid into inset 211 in this example cannot move in any other dimension. Inset 211 and/or capturing edge 212 may include adjustable sizing or compressible or deformable lining, such as a foam tape about inset 211, to accommodate devices of somewhat varying size and may further include high-friction surfaces, adhesives, locks, and/or clamps to retain a portable electronic device within inset 211 once inserted.

As shown in FIG. 2, example embodiment console 200 may include a speaker 215 at a front of frame 210 where a retained mobile device may be viewed and/or interacted with. Speaker 215 may be a passive speaker, connecting to a speaker of the mobile device through a passage, such as an amplifying channel 216 in frame 210. Amplifying channel 216 may be a hollow space with high acoustic transmission, so as to direct and amplify sound from a mobile device secured with frame 210 out of speaker 215. Amplifying channel may include a narrower opening in frame 210 next to an anticipated audio output of a mobile device and gradually widen to speaker 215. In this way, amplifying channel 216 may concentrate and direct sound output to a front of console 200 where a user will view or interact with a mobile device inserted therein. Amplifying channel 216 may be positioned with a speaker location of several known devices. For example, amplifying channel 216 may open near a bottom or side of inset 211 where a speaker of a corresponding smartphone, media player, tablet computer, smart watch, etc. would be located. In this way, inset 211, frame 210, amplifying channel 216, and other features of example embodiment console 200 may be sized and positioned for a particular mobile device and/or class of devices.

As shown in FIG. 2, a base 240 connects to mobile frame 210 via a neck 230. In example embodiment console 200, mobile frame 210 is rotatable in multiple dimensions through ball 235 at an end of neck 230 and socket 213 in frame 210. Socket 213 may completely or partially surround ball 230 so as to prevent base 240 from becoming separated from frame 210, while permitting rotation of frame 210. Socket 213 may form a larger cavity or flange about a base of ball 235 to permit greater degrees of rotation of frame 210, such as 90-degree or greater rotation in any dimension. Alternatively, socket 213 may be shaped in a more surrounding configuration to permit less rotation. Still further, socket 213 may include irregular spaces, flanges, or cut outs from frame 210 to allow rotation or other movement of frame 210 only in specific dimensions.

Ball 235 may include a gripping or adhesive surface that secures with socket 213 when not subject to user or other forces intended to move frame 210 relative to base 240. For example, ball 235 may include a rubberized or other highly-frictional surface that requires purposeful force to move frame 210 and socket 213 relative to ball 235. Or for example, ball 235 may be covered with small bumps as regular intervals, and socket 213 may have similarly-shaped divots; such bumps and divots may lock frame 210 at any one of several positions and/or orientations, while allowing movement between positions under appropriate human force. Ball 235 and/or socket 213 may further include tracks, blocks, magnets, keepers, ratchets, and any other mechanism to control relative movement of the two. In this way, frame 210 may be moveable to any desired position under human force, and surfaces on ball 235 and/or socket 213 may retain that desired position absent human manipulation. It is further understood that ball 235 may be ellipsoidal or any other shape to produce desired movement and/or complete or partial securing with respect to base 240.

Ball 235 is shown in FIG. 2 as mating with socket 213 vertically below and horizontally behind a center of inset 211. Through this positioning, inset 211 and any portable electronic device inserted therein will be vertically above a point of rotation of frame 210 when in the position of FIG. 2. This positioning may allow a user more leverage to rotate frame 211 when grasped about a mobile device in inset 211 by providing additional torque against ball 235 in any orientation. Of course, socket 213 may be positioned anywhere in frame 210 so as to enable any relative movement of an inset 211 and mobile device therein and base 240 or ball 235. Still further, weights or appropriate mass positioning in frame 210 may balance frame 210 against an expected mobile device weight and allow even, or at least static, positioning of frame 210 at any orientation.

Base 240 and neck 230 may be shaped and positioned in any manner with respect to each other and frame 210. For example, neck 230 may be telescoping or articulating with respect to base 240 in order to permit translation of frame 210 in a desired direction, such as at a desired viewing height. Or base 240 and neck 230 may be static or rigidly affixed so as to permit only rotation of frame 210.

Example embodiment console 200 may be fabricated of any desired material(s). For example, base 240, neck 230, and frame 210 may be entirely molded of a resilient plastic, simplifying manufacturing processes and costs. Additional gripping, compressible, or adhesive materials may be added to the plastic at various positions to accommodate functionality discussed above. Still further, individual components of example embodiment console 200 may be individually manufactured from metals, woods, glass, etc. and assembled.

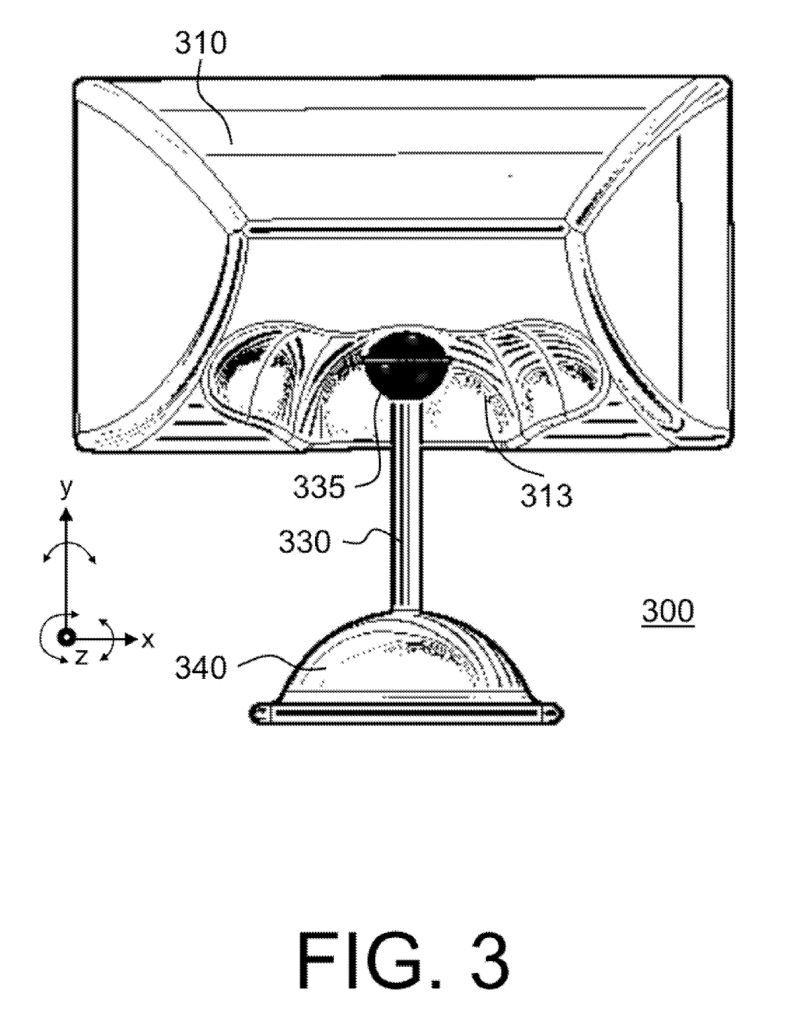

FIG. 3 is an illustration of an example embodiment portable electronic device console 300 illustrating another joining option between base 340 and frame 310 via neck 330, ball 335, and cavity 313, useable with any other example embodiment. As shown in FIG. 3, cavity 313 may be irregular and hollowed out in specific dimensions. Ball 335 may be joined in a partially-surrounding area so as to prevent translation of frame 310 with respect to base 340 but allow rotation. Cavity 313 may be shaped to permit simultaneous rotation of 360-degrees about a vertical y axis, at least 90-degrees about a horizontal x axis, and a variable about of rotation about a depth z axis depending on rotation in other axes, permitting a mobile device held by frame 310 to be viewed at several different orientations, including both landscape and portrait positions with respect to a vertical.

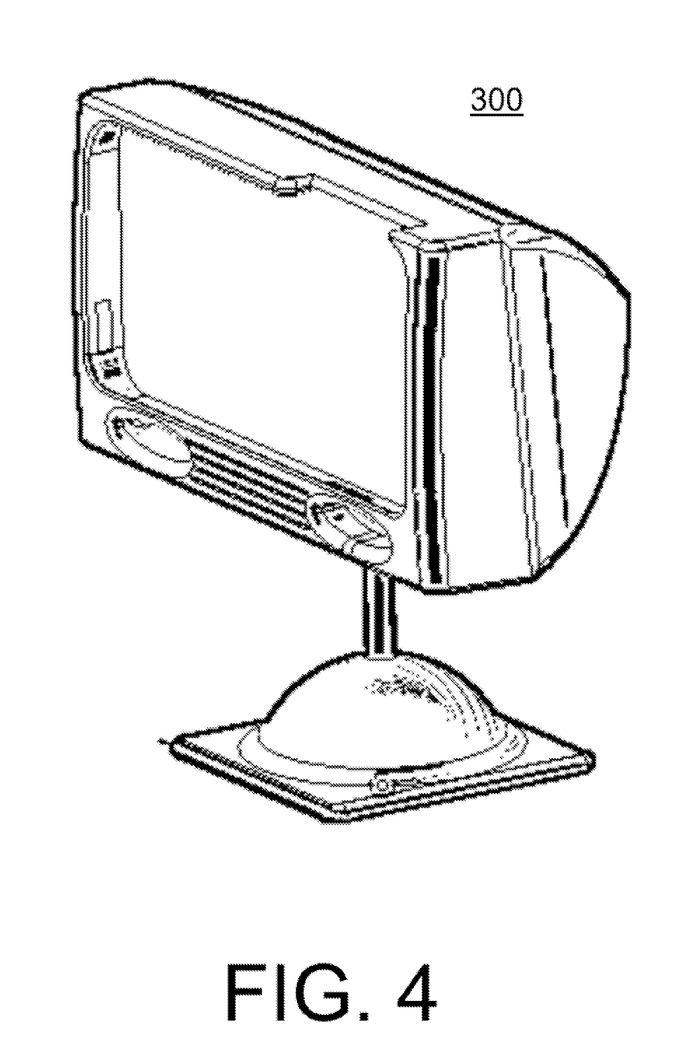

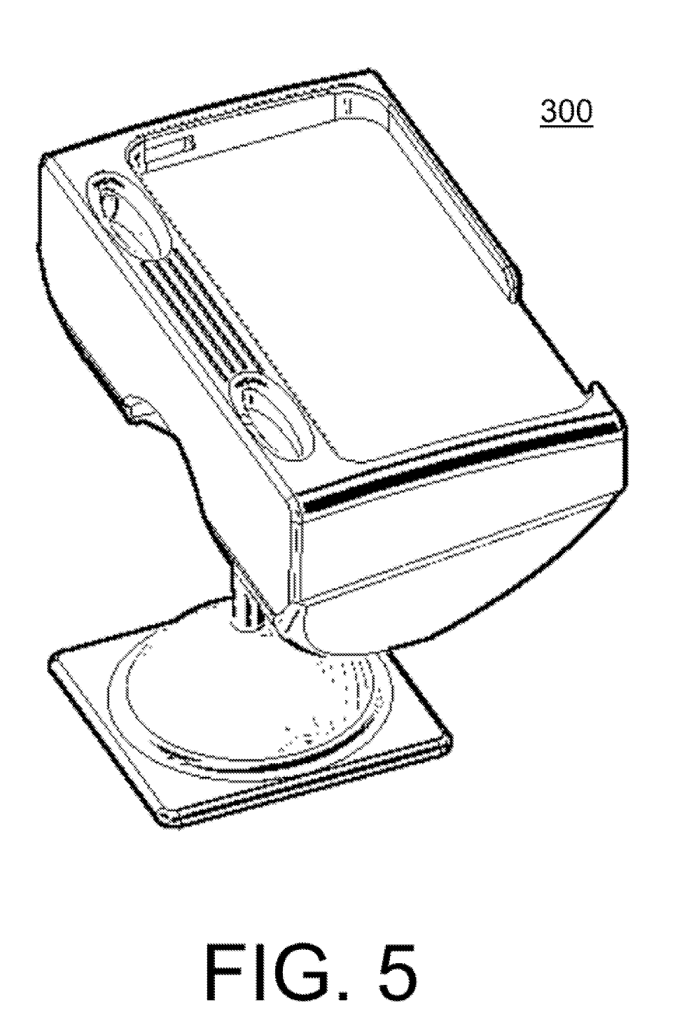

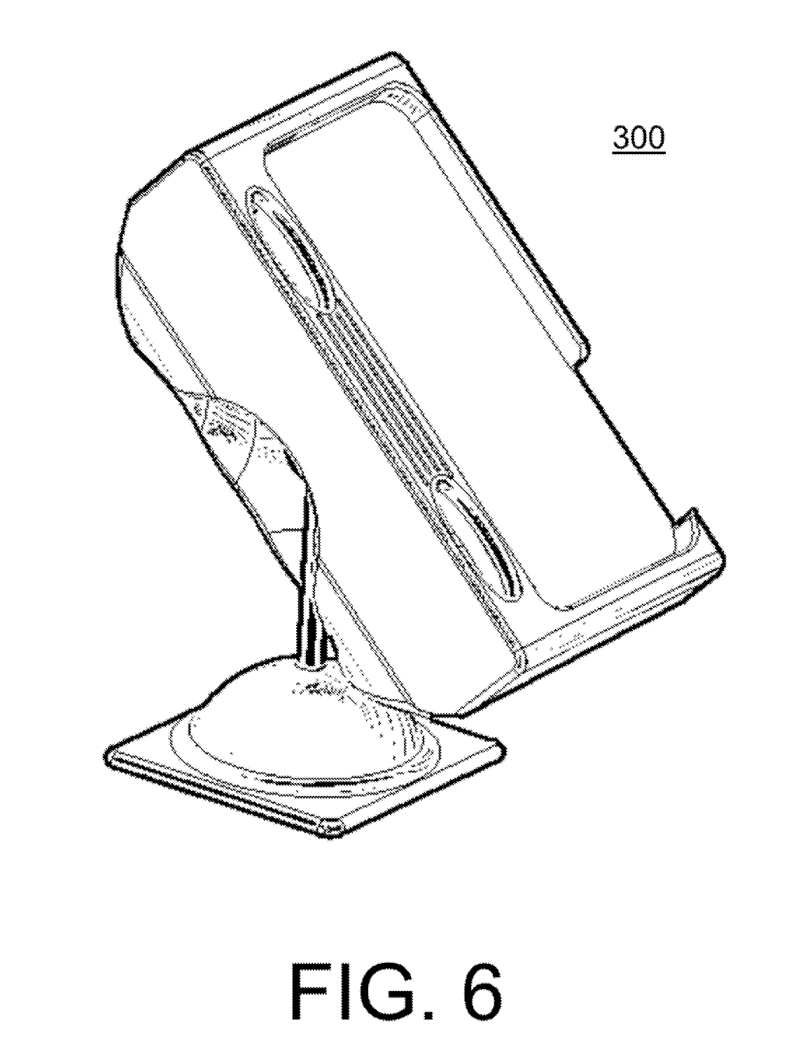

FIGS. 4-6 are further illustrations of example embodiment console 300 showing use of the same in several different orientations. As shown in FIGS. 4-6, example console 300 may be rotated in several different directions to produce a watchable vantage of any orientation or positioning, based on user needs. The viewer and base of the console 300 may remain in static orientation once set by a user, such that console 300 can achieve and maintain any desired viewing angle, direction, or orientation through use of proper joints between the two.

Some example embodiments being described here, it is understood that one or more examples and components thereof may be used in combination and/or in duplication to produce multiple options and functionalities for viewing communications devices. It will further be appreciated by one skilled in the art that example embodiments may be varied through routine experimentation and without further inventive activity. For example, although a ball and socket joint is shown at a particular position in some examples, it is understood that multiple extension cylinders with resistance may be used between a base and frame to produce desired relative positioning. Variations are not to be regarded as departure from the spirit and scope of the exemplary embodiments, and all such modifications as would be obvious to one skilled in the art are intended to be included within the scope of the following claims.

What is claimed is:

1. An apparatus for positioning and displaying a mobile device, the apparatus comprising:
a base including an extension terminating with a ball; and
a viewer including,
a holder configured to secure the mobile device to the viewer such that the holder and mobile device remain statically co-located in any orientation, and
a cavity shaped to capture the ball such that the viewer is rotatable in three mutually perpendicular axes with respect to the ball and cannot be separated from the base, wherein at least one of the ball and the cavity include a surface that prevents the viewer from rotating without human force.

2. The apparatus of claim 1, wherein the surface is a plurality of raises on the at least one of the ball and the cavity and a plurality of indentations matching the raises on the other of the ball and the cavity.

3. The apparatus of claim 2, wherein the base and the viewer are both formed entirely of molded plastic.

4. The apparatus of claim 1, wherein the viewer further includes a sound channel opening in the holder and at a front of the viewer, wherein the sound channel conducts sound from a speaker in the mobile device in the holder to a speaker in the front of the viewer.

5. The apparatus of claim 1, wherein the ball is spherical and the cavity is spherical, and wherein the ball is captured in the cavity so as to allow only rotation of the viewer relative to the base.

6. The apparatus of claim 5, wherein the viewer further includes a cut-out area adjacent to the cavity that permits rotation of the viewer until the extension directly contacts the viewer.

7. The apparatus of claim 1, wherein the holder includes a retaining edge and a receiving space for the mobile device, wherein the receiving space and the retaining edge are together sized and positioned to permit the viewer and mobile device to move in only a single dimension relative to one another when installing the mobile device.

8. A passive apparatus for positioning and displaying a mobile device, the apparatus comprising:
a base including an extension with a connecting end; and
a viewer including,
a holder configured to secure the mobile device to the viewer such that the holder and mobile device remain statically co-located in any orientation, and
a cavity shaped to capture the connecting end such that the viewer is moveable with respect to the base and cannot be separated from the base, wherein the passive apparatus includes no electronics and wherein the viewer does not accommodate an external power connection to the mobile device.

9. The apparatus of claim 8, wherein the viewer further includes a sound channel, wherein the sound channel is hollow and terminates at an opening in the holder and at an opening in a front of the viewer, and wherein the sound channel conducts sound from a speaker in the mobile device in the holder to a speaker in the front of the viewer.

10. The apparatus of claim 9, wherein the holder includes a retaining edge and a receiving space for the mobile device, wherein the receiving space and the retaining edge are together sized and positioned to permit the viewer and mobile device to move in only a single dimension relative to one another when installing the mobile device.

11. The apparatus of claim 10, wherein the connecting end is a sphere, and wherein the cavity is spherical such that the viewer is immovable with respect to the base except for rotation.

12. An enhanced viewing apparatus for positioning and displaying a mobile device, the apparatus comprising:
a base including an extension with a connecting end; and
a viewer including,
a holder including a retaining edge and a receiving space for the mobile device, wherein the receiving space and the retaining edge are together sized and positioned to permit the viewer and mobile device to move in only a single dimension relative to one another when installing the mobile device, and
a cavity shaped to capture the connecting end such that the viewer is moveable with respect to the base and cannot be separated from the base.

13. The apparatus of claim 12, wherein the holder includes a gap permitting external access to controls in an edge of the mobile device.

14. The apparatus of claim 12, wherein the viewer further includes a sound channel, wherein the sound channel is hollow and terminates at an opening in the receiving space and at an opening in a front of the viewer, and wherein the sound channel conducts sound from a speaker in the mobile device in the receiving space to a speaker in the front of the viewer.

15. The apparatus of claim 12, wherein the apparatus includes no electronics and does not accommodate an external power connection to the mobile device.

16. The apparatus of claim 12, wherein the connecting end is spherical, and wherein the cavity is spherical such that the viewer is immovable with respect to the base except for rotation.

17. The apparatus of claim 16, wherein the viewer further includes a flange adjacent to the cavity such that the viewer can be rotated at least 90 degrees with regard to three mutually perpendicular axes.

18. The apparatus of claim 17, wherein the center of the spherical is entirely below the holder such that no axis of rotation of the viewer intersects the holder and the mobile device.

19. The apparatus of claim 17, wherein at least one of the connecting end and the cavity include a surface that prevents the viewer from rotating without human force, and wherein the surface is a plurality of raises on the at least one of the connecting end and the cavity and a plurality of indentations matching the raises on the other of the connecting end and the cavity.

20. The apparatus of claim 12, wherein,
the connecting end is a spherical ball having a locking surface,
the cavity is spherical and has a locking surface to match and capture the spherical ball, allowing the viewer to be moved relative to the base only via rotation about the ball under external human force,
the viewer further includes a cut-out area that permits the rotation until the extension directly contacts the viewer,
the viewer further includes a sound channel, wherein the sound channel is hollow and terminates at an opening in the receiving space and at an opening in a front of the viewer, and wherein the sound channel conducts sound from a speaker in the mobile device in the receiving space to a speaker in the front of the viewer,
the viewer and the base are formed entirely of molded plastic, and
the apparatus includes no electronics and wherein the viewer does not accommodate an external power connection to the mobile device.
